(19) United States
(12) Patent Application Publication
(10) Pub. No.: US 2005/0187807 A1
(43) Pub. Date: Aug. 25, 2005

(54) Method and computer system for online appearance notification and confirmation

(76) Inventors: Leslie F. Delatte, Dallas, TX (US); Gregory E. Price, Frisco, TX (US)

Correspondence Address: LOCKE LIDDELL & SAPP LLP;ATTN: SUE COTT, 2200 ROSS AVENUE, SUITE 2200, DALLAS, TX, 75201-6776, US

(21) Appl. No.: 10/783,341

(22) Filed: Feb. 20, 2004

(51) Int. Cl. G06F 17/60

(52) U.S. Cl. 705/9

(57) ABSTRACT

A method, system, and computer program product for coordinating court scheduling with subpoena and summons notification processes for any employee of a government organization or citizen. The system preferably uses a standard web interface to receive court dates from various courts within a city and or county (or other government entity), automates the notification to government employees to appear or standby, and receives verification of their receipt of their notification. If there are conflicts in the court date and the individual being requested to appear or standby, the system automatically notifies the issuer and coordinates the proper notification alternative action automatically.

A portion of the disclosure of this document contains material that is subject to copyright protection. Reproduction of the disclosure as it appears in the Patent & Trademark Office patent files or records is permitted, but otherwise the copyright owner reserves all rights.

### BACKGROUND OF THE INVENTION

1. Technical Field

The present invention relates generally to an online court appearance notification and confirmation system for use by courts and law enforcement personnel.

2. Description of the Related Art

The current process for notifying police officers to appear in court as witnesses involves numerous paper documents, manual communications and a large amount of wasted time scheduling and rescheduling court dates. Typically, police offices today receive their notifications to appear in court through multiple paper documents or verbal communications. An officer who has received such notice then goes to court at the scheduled time. Court schedules and dockets, however, are subject to frequent delay and other variables. Quite often, an officer goes to court for the appointed matter, only to find that the schedule has been changed. Officers required to appear or standby to appear in court typically arrive to wait for hours, only to be rescheduled to appear again. Last minute cancellations cannot be communicated rapidly, leaving the officers to arrive only to find out they were already rescheduled. When court dockets are constantly changing, officers sometimes miss their court appearances, allowing traffic tickets to go undisputed, which results in further lost revenue for the city. Officers, however, must be paid for their time, usually by way of overtime payments, and such payments can amount to millions of dollars annually for a large city. The prior art approach often results in further wasted time for the personnel who have to manual scheduling and reschedule court dates.

### BRIEF SUMMARY OF THE INVENTION

It is a general object of the present invention to provide an appearance notification and confirmation system for use by court personnel and law enforcement officers.

It is another more specific object of the invention to provide a court case (or “docket”) scheduling system preferably using a Web interface to schedule court dates, to notify police officers about court appearances (e.g., whether actual or standby), and to enable officers to respond to docket notice verification.

It is still another object of the invention to provide for more efficient subpoena notification and confirmation in an environment in which court and law enforcement personnel interact.

It is another object of the invention to provide an docket scheduling system that simplifies the current complexity in the court scheduling process by automating the online scheduling and notification for court personnel, police officers, and their supervisors.

It is still another object of the invention to provide a method and computer system for coordinating court scheduling with subpoena and summons notification processes for any employee of a government organization or citizen. The system preferably uses a standard web interface to receive court dates from various courts within a city and or county (or other government entity), automates the notification to government employees to appear or standby, and receives verification of their receipt of their notification. If there are conflicts in the court date and the individual being requested to appear or standby, the system automatically notifies the issuer and coordinates the proper notification alternative action automatically.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is an illustrative modify docket display screen that may be used by a court administrator who is responsible for creating dockets within the system;

FIG. 2 is an illustrative modify docket display screen that includes a pop-up calendar from which an administrator may select a court date;

FIG. 3 illustrates a representative conflict for a court date display screen that may be generated when a user attempts to set or modify a court date using the inventive system;

FIG. 4 is an illustrative Suggested Dates Without Conflict or Check new dates screen that may be generated when a user selects the Suggest a Reciprocal Date link in the display of FIG. 3;

FIG. 5 illustrates an example email of a Disregard notice that is issued to a witness by the system automatically when a permitted user enters a new date on the Suggested Dates Without Conflict or Check new dates screen of FIG. 4;

FIG. 6 illustrates a List of Witnesses and Notification Status display screen used in an illustrative embodiment of the present invention;

FIG. 7 illustrates an update to the display screen of FIG. 6, which update may occur when a permitted user takes a given action with respect to the Suggested Dates Without Conflict of Check new dates screen of FIG. 4;

FIG. 8 illustrates a Search For Registrants to add a Witness to a Docket display screen according to an illustrative embodiment of the invention;

FIG. 9 illustrates an example email notifying a witness that he or she is expected to Appear at a given court at a given date and time;

FIG. 10 illustrates a representative notification email notifying a witness that he or she is on Standby to appear at a given court at a given date and time;

FIG. 11 illustrates a representative notification email notifying a witness that he or she can Disregard a past notification to attend (and that he or she has been dismissed);

FIG. 12 illustrates the List of Witnesses and Notification Status docket screen (of FIG. 7) with one or more personnel conflicts shown;

FIG. 13 illustrates a representative escalation email sent to a witness;

FIG. 14 illustrates a representative escalation email sent to a supervisor;

FIG. 15 illustrates a notification history for a particular witness on the docket;

FIG. 16 illustrates a representative “home” display screen for an individual witness, such as a police officer who is expected to be summoned to testify at a given court on a given court date;

FIG. 17 illustrates a representative example of an Impending Items portion of the “home” display that include a summation of delinquent activity requiring immediate attention;

FIG. 18 illustrates a representative display screen by which an officer can request a leave; and

FIG. 19 illustrates a message that may be delivered to an officer that requests leave that conflicts with a docket notification.

### DETAILED DESCRIPTION OF A PREFERRED EMBODIMENT

The present invention provides a method, system, and computer program product for coordinating court scheduling with subpoena and summons notification processes for any employee of a government organization or citizen. The system preferably uses a standard web interface to receive court dates from various courts within a city and or county (or other government entity), automates the notification to government employees to appear or standby, and receives verification of their receipt of their notification. If there are conflicts in the court date and the individual being requested to appear or standby, the system automatically notifies the issuer and coordinates the proper notification alternative action automatically.

The prior art involved a manual, inefficient process. Assume that a particular court matter needs to be scheduled by the court clerk. If the matter involves a criminal charge, typically a police officer will need to appear as a witness. The officer must be notified of the time and place of the case. To this end, typically a clerk or other person in the district attorney (DA) office posts docket dates and fills out a paper form for each police agency involved in a given case. Then, an officer typically hand carries the form to each police department. At the police department, the form must then be routed to the appropriate individuals. If scheduling conflicts arise, those conflicts must be noted on yet another form, then mailed or hand carried back to the DA's office. The DA fills in a conflict form, and the form is hand carried back to the court clerk. The process is then repeated as often as needed to set the court date. When the officer then goes to court (either to appear or to standby), the previously scheduled court date may already have been changed.

The present invention addresses the significant inefficiencies in the prior art. Generally, the court clerk inputs docket dates into the inventive court notification system. If a scheduling conflict exits, the system automatically recommends a next available date. The system then creates and transmits to the police officer, preferably via email, a notification subpoena. As used herein, “subpoena” should be construed broadly to cover any notice or other appearance requirement, regardless of how designated. When the officer reads the docket date details in the notice, he or she can then verify the schedule, preferably via an email receipt. If the court date/time changes, the officer is notified automatically. The officer can then attend the scheduled docket case with confidence that his or her time will not be wasted.

Preferably, the inventive court notification system may be used by various types of users: police officers, police supervisors, police administrators, court administrators, and master administrators. These categories are merely exemplary, and one or more individuals may fall within more than one category. Generally, police officers are then entities that are being scheduled to appear at courts. They receive emails notifying them of court docket scheduling details, including (for example) the date and time of their appearance and/or standby requirements. They may also use the system to request scheduled leave, and to document communications with their supervisors. Police supervisors typically are responsible for managing the agency's chain-of-command, minimizing escalation notices, and approving requested leave dates. As will be described below, according to a feature of the present invention, a supervisor may also be afforded the ability to enter an appearance acknowledgement on behalf of an officer, or to enter such an acknowledgement with an given exception. Police administrators typically are responsible for assisting their agency's officers and supervisors in acknowledging court dockets. They typically have the ability to acquire acknowledgements manually and to create dockets within their own agency. Court administrators typically are responsible for creating dockets within the system, adding officers to the dockets, scheduling dates, and monitoring court docket acknowledgements. Master administrators typically are able to perform all user group functions, as well as to add new agencies and to handle user import activities. As noted above, the above characterizations are merely exemplary, and they should not be taken to limit the scope of the present invention. Typically, each entity as described above has (or has access to) a computer (or personal digital assistant) device having commodity hardware, an operating system, a network interface, input/output devices, and an application that provides the inventive functionality.

In a representative embodiment, once a user sets or changes a court date, notifications to the witnesses (or other involve persons) must be sent out. Preferably, there are several methods to send out notifications: Individual Notifications (allows the user to send notifications to each person individually), Notify All (sends the notification to all witnesses or others associated with the docket that are in a “standby” or “appear” Request Type status), or Disregard All (sends notifications to all witnesses or others associated with the docket to disregard any current requirement to appear or standby to appear). In this illustrative embodiment, there are preferably four (4) different Request Types that can be set for a given individual: Appear (requests for the individual to appear in court), Standby (requests for the individual to standby, i.e., be available if called) to appear in court), Not Set (referring to a witness that has been added to the docket but not yet determined if he or she is needed to appear or to standby), and Disregard (meaning that the witness is not going to be needed to standby or to appear in court). When an entity receives a notification, he or she is expected to provide an acknowledgement to that notification. The acknowledgement may be provided as an electronic communication, such as by email, by a page, or the like. An acknowledgement need not be an electronic communication, nor does an acknowledgement have to be initiated from a notification directly.

A distributed computing environment in which the court notification method and system of the invention may be implemented includes a set of computing-related entities (systems, machines, processes, programs, libraries, functions, or the like) that facilitate or provide a client-server network. In a typical implementation, the environment typically comprises a set of computers. A representative machine is a client workstation or a network-based server running commodity (e.g. Pentium-class) hardware, an operating system (e.g., Linux, Windows 2000, OS-X, or the like), an application runtime environment (e.g., Java), and a set of applications or processes (e.g., Java applets or servlets, linkable libraries, native code, or the like, depending on platform) that provide the functionality of a given system or subsystem. A client machine typically includes a Web browser (Internet Explorer, Netscape Navigator, Apple Safari, or the like) or other rendering engine. A Web browser typically includes or supports media players and other plug-ins. The present invention implements a distributed environment that enables the above-described entities (or others) to establish and implement (for example) online subpoena notifications and confirmations over a network including, without limitation, the publicly-routable Internet, an intranet, a virtual private network, or any combination thereof. The method may be implemented as a standalone product, or as a managed service offering. Moreover, the method may be implemented at a single location, or across a set of locations. It may be implemented in a wide area network, a local area network, a public or private network, or wireless network, or any combination of the above. Preferably, given users of the system are afforded access privileges, e.g., user logon and password mechanisms, and various components of the system typically interface over secure links (e.g., SSL). Generalizing, any given functionality of the present invention may be implemented as a set of instructions, code sequences, configuration information and other data. Moreover, as used herein, references to hardware may be deemed to include any software necessary to operate that hardware. In one embodiment, a representative client machine used by a police officer is a personal computer notebook computer, Internet appliance or pervasive computing device (e.g., a PDA or palm computer) that is x86-, PowerPC®- or RISC-based. The client includes an operating system such as Microsoft Windows, Microsoft Windows CE or PalmOS. As noted above, the client includes a suite of Internet tools including a Web browser.

The machines associated with the court typically support other administrative functions. At least one or more machines may also support suitable databases, such as a relational databases (e.g., Oracle, SQL, mySQL, or the like) in which the data created by the system users is stored.

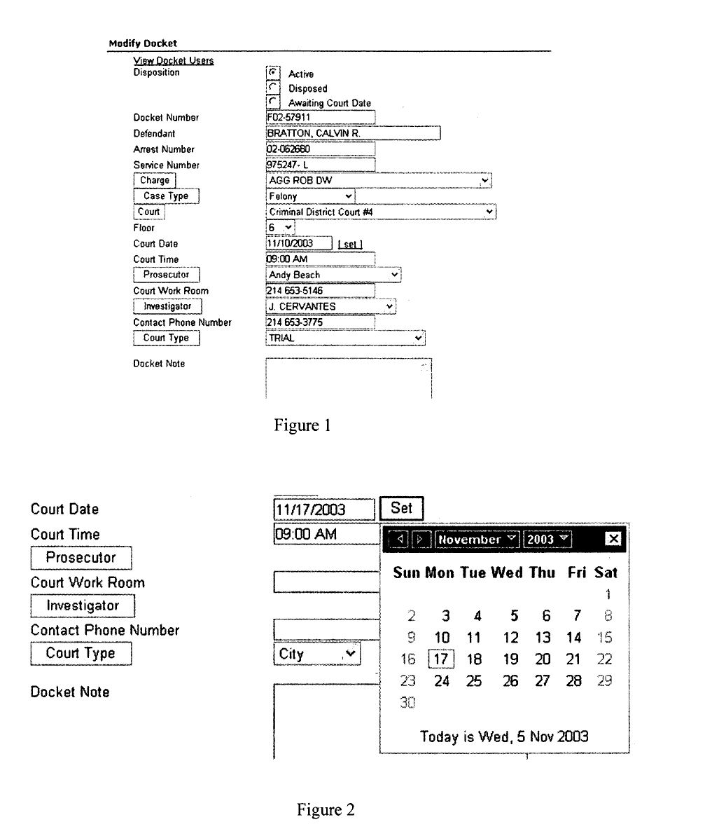

The online appearance and notification system of the present invention includes appropriate display routines for generating a set of display screens that together comprise a user interface for the system. The particular display screens that are generated depend on the user's role in the system, of course. FIG. 1 illustrates a representative modify docket screen for use by a court administrator responsible for creating dockets within the system and scheduling associated court dates. Entry of data in this display triggers several possible actions, as will be described. Preferably, the modify docket screen of FIG. 1 exports, upon request by authorized users, a web page view that includes court and docket data. Although not shown in detail, the data that populates this display is generated and stored in the system (preferably in a relational database) using a set of administrative display screens from which a master administrator (or other permitted entity) may add a new user and/or modify a user profile, inactivate or disable a given user, add a new agency and/or modify an agency profile, add an entry for a given court and/or modify a court profile, associate a prosecutor (or set of prosecutors) to a given court, and the like.

The display of FIG. 1 typically includes a docket disposition portion comprising a set of radio buttons: Active, Disposed and Awaiting Court Date. When a case is Active it is considered to be “live” within the system. After a case has been Disposed, preferably it is automatically archived and can be accessed with all detail history by authorized users. The Awaiting Court Date radio button may be selected when a court date has not be set. In particular, a case may also exist and witnesses can be associated with the case, together with all docket details, even though there is no court date. Using the display of FIG. 1, the case history file data may be collected even if the district attorney's office has yet to decide if it will file the case or if there will be a plea bargain obviating a court date.

The display of FIG. 1 also preferably includes appropriate fields for text entry of data about the case and the accused: Docket Number, a Defendant, an Arrest Number, a Service Number, are merely representative. Preferably, the display includes a Charge field, together with a pull-down menu from which the administrator can select an alleged offense. The display also preferably includes a Case Type field, together with a pull-down menu from which the administrator can select a type, such as Felony, Misdemeanor, or the like. A Court field has an associated pull-down menu from which the administrator can select a particular court. A Floor field has an associated pull-down menu from which the administrator can select a particular floor. Similar fields and pull-down menus may also be included for the Prosecutor, Investigator and Court Type fields, as illustrated. In this example, the modify docket screen also includes fill-in text fields for Court Time, Court Work Room, and Contact Phone Number. Of course, these text and display fields are merely exemplary. The use of the modify docket screen is advantageous in that it simplifies the ability for authorized users to add and remove items from the various pull-down menus on the screen. This allows for the system to be easily administered by the users. It also maintains the system based on changes within the courts, attorney's office, felony or misdemeanor case types, or associated investigators.

As also seen, the display screen includes a Court Date field having a set hypertext link associated therewith. Selection of the link preferably opens a display calendar, such as illustrated in FIG. 2. Preferably, the user (e.g., the court administrator) sets the scheduled court data by selecting the set button and choosing the associated calendar date.

Preferably, the system allows for users to set their defaults, and then having the system automatically populate at least the following fields: Court, Prosecutor, Investigator and Court Type. This default functionality is desirable, as often individuals are assigned to the same court, prosecutor, investigator, or court type. The system allows users to populate their default settings for the system, and those defaults are automatically selected whenever that user creates a new docket. Of course, the user can always overwrite the default setting in the event that they are working with items different from their default settings.

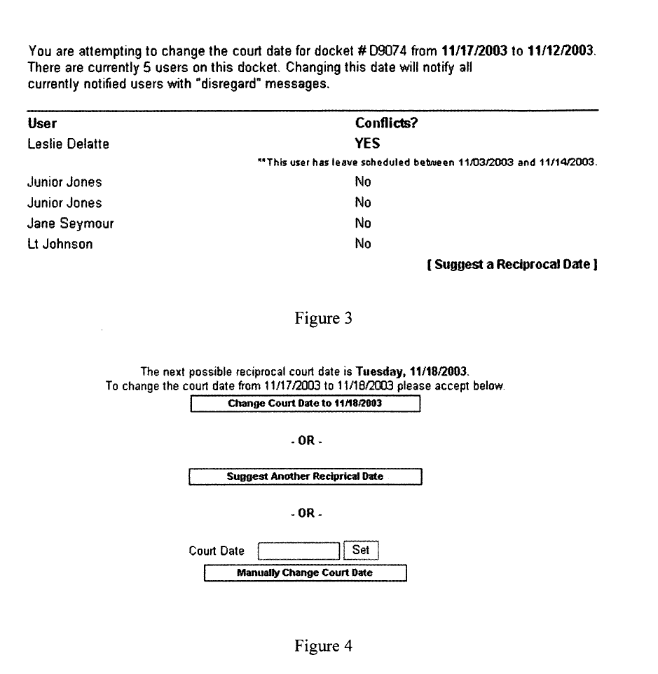

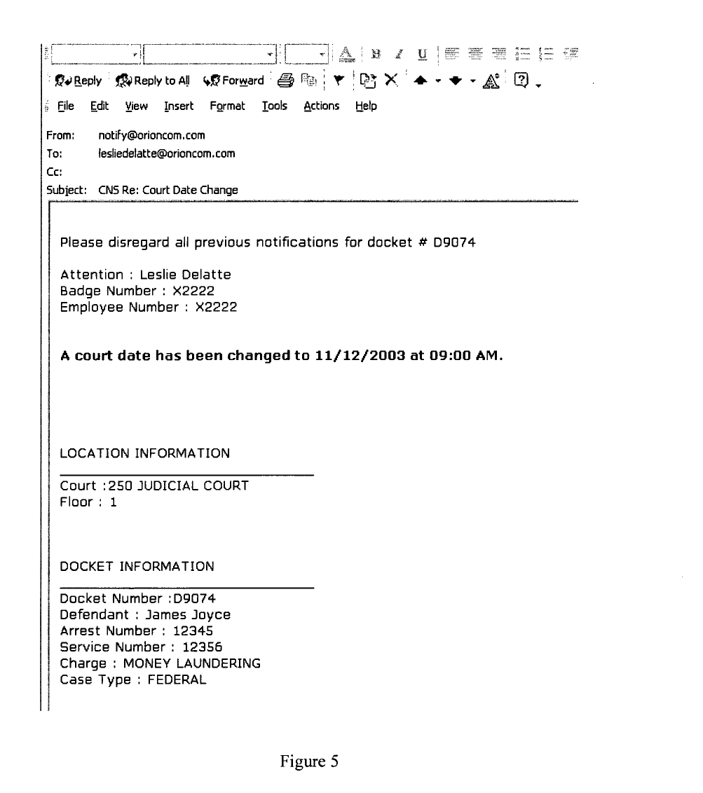

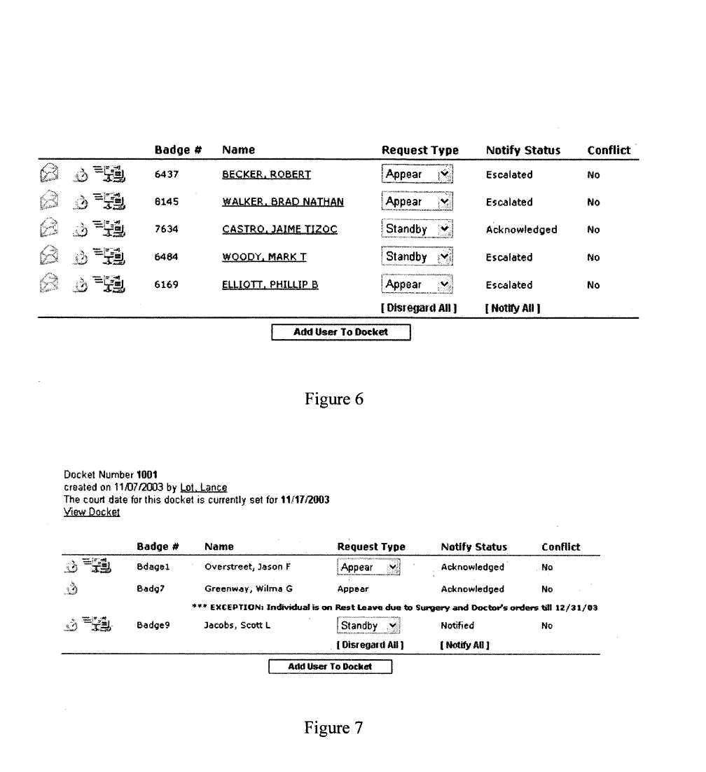

Once an authorized user selects the court date as illustrated in FIG. 2, he or she (or some other authorized user) can change the date. Whenever a previously-set court date is modified, the system preferably automatically monitors if that court date will create a scheduling conflict for any of the witnesses associated with the docket. If there is a conflict, preferably a new display screen appears indicating the issues with the date. FIG. 3 illustrates a representative conflict for a court date display screen. As can be seen, this screen identifies the particular individuals that may be or are needed and their potential conflict(s). If a particular witness or individual is considered critical to the case, the user may then select a Suggest a Reciprocal Date link to receive an indication of a next “best” date when all witnesses are available. Selection of the Suggest a Reciprocal Date link in the display screen of FIG. 3 navigates the user to a display such as illustrated in FIG. 4. FIG. 4 is an illustrative Suggested Dates Without Conflict or Check new dates screen. As can be seen, preferably the display in FIG. 4 includes a number of controls. A default Change Court Date provided by the system can be selected by having the user simply select the Date offered. Alternatively, the user can enter some other date manually. To this end, the display preferably includes a Court Date field in which the user can enter a date and select the Manually Change Court Date button to effect such a change. This causes several related control actions to be carried out. In particular, if this option is selected and there is no conflict with the new date, the system preferably automatically sends out (e.g., via email) Disregard notifications informing any affected witness that a prior scheduled date is no longer valid. FIG. 5 illustrates an example email of a Disregard notice sent to a witness or other individual affected by the date change. In addition, when a new date has been entered manually (and does not create a new conflict), the system preferably also automatically updates a notification status of all witnesses or others otherwise involved with respect to the docket. In particular, preferably the system maintains a display screen that lists all the witnesses associated with a given docket and their current (i.e., real time) notification status. FIG. 6 illustrates a representative List of Witnesses and Notification Status display, which accomplishes this function. When a user has changed the court date a described above, the display of FIG. 6 is automatically updated, e.g., changing the status of the affected individual with an Appear or Standby status to Not Notified. This is illustrated in FIG. 7. For any user with a conflict on the new scheduled court date, the system preferably prevents them from being notified to appear or standby for the new court date. All other users with request type of Appear of Standby are placed in a Not Notified status and preferably a notification icon is available next to their names. This allows the user to notify only “available” personnel to appear to standby for the court date.

If there is a new conflict created by the new date that has been entered, the screen reappears.

As also seen in FIG. 4, instead of accepting the default selection or entering a new date manually, the user may also select a Suggest Another Reciprocal Date control. This action causes the system to automatically present to the user a next available date for all witnesses that are in a Standby or Appear status mode. The user can then select to use the provided date. If the user does so, the system automatically sends out email Disregard notifications (as illustrated in FIG. 5) and automatically updates the notification status of all witnesses, changing anyone with an Appear or Standby status to Not Notified (as illustrated in FIG. 7).

If any of the above-identified actions with respect to FIG. 4 create a new scheduling conflict, the process is repeated.

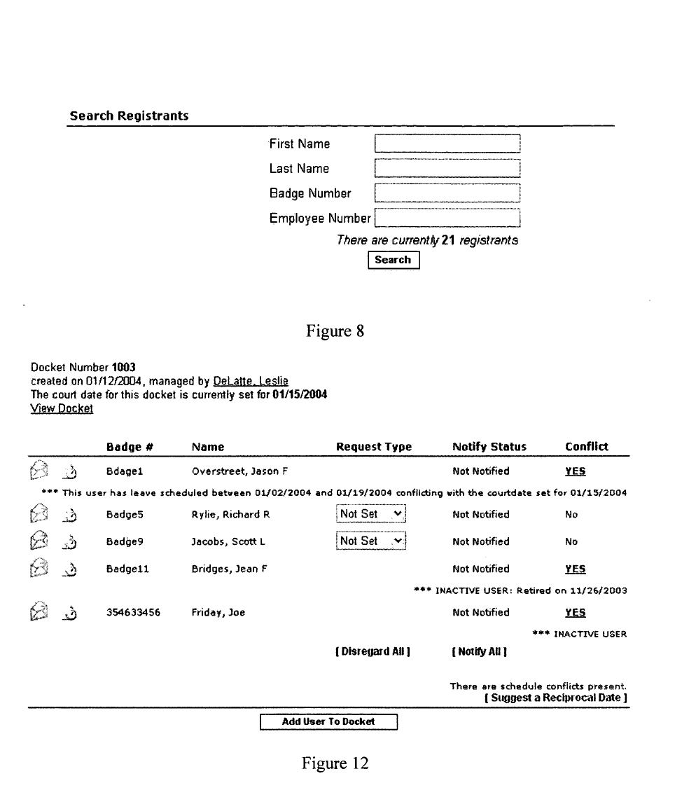

Referring now back to FIG. 1, the docket display includes a View Docket Users link. Selection of that link enables an authorized user to see what witnesses are currently assigned to the docket, their real-time notification status, and to add new users to a docket. FIG. 6 illustrates a desired interface display. If the user selects the Add User to Docket control, a display such as illustrated in FIG. 8 is exported for viewing. As illustrated in FIG. 8, the system allows the user to enter an identifier for a witness (e.g., by First Name, Last Name, Badge Number or Employee Number), or the user can perform a search using a query lookup into a database of registrants. Preferably, a duplicate entry of the same person on a docket is disallowed. One that person is selected on a docket, their option for being selecting second time is disabled.

In an illustrative embodiment, the user may change a Request Type associated with a witness, in which case preferably the system automates a notification of the Request Type change. This can be accomplished as follows. When the user adds a witness to a docket (using the display of FIG. 8), the new witness is preferably added to the docket under the Name column, the Request Type status (for that witness) defaults to a “Not Set” setting in the associated drop-down menu (which may also include the settings Appear, Standby, and Disregard), and a “Notify Status” column is set to “Not Notified.” If the user then changes the Request Type to Appear of Standby (by selecting one of these entries from the drop-down menu), the system preferably in real-time checks for court date conflicts, e.g., to see whether the newly-added witness has already requested and obtained a pre-approved leave. If there is a conflict, the user is inhibited from sending out a notification. If there is no conflict the user can select a notification icon associated with the new witness to send out the notification. If the user selects the Notify All link, the system preferably sends out notifications to all witnesses for any witness that had a Request Type change (and that is current status—Not Notified with no conflicts).

Thus, when a witness entry in the display of FIG. 7 is set to Not Set, there are no notification requirements. When a witness status changes from any other request type to Not Set, preferably the system provides the user with a notification button to notify the user of the change in request type. When a witness is set to Appear or Standby and their request type changes, the user status preferably will change to “Not Notified,” which indicates to the user that the witness needs to be notified of the change. Once the user selects the notification icon (or other Notify button) and notifies the witness, the witness status changes to Notified. Likewise, when a user is set to Disregard from an Appear or Standby status, preferably the system sends out an email to the witness notifying the witness of the status change. In such case, once the user selects the notification icon and notifies the witness (of the status change to Disregard), the status changes to Notified.

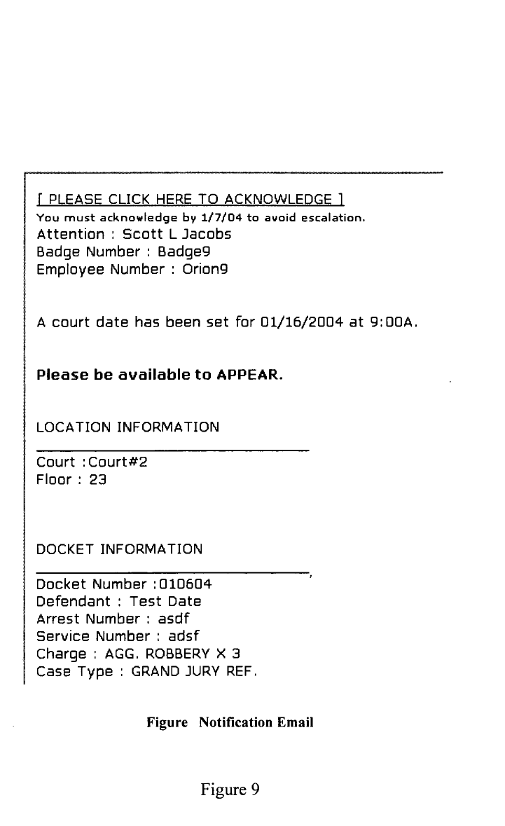

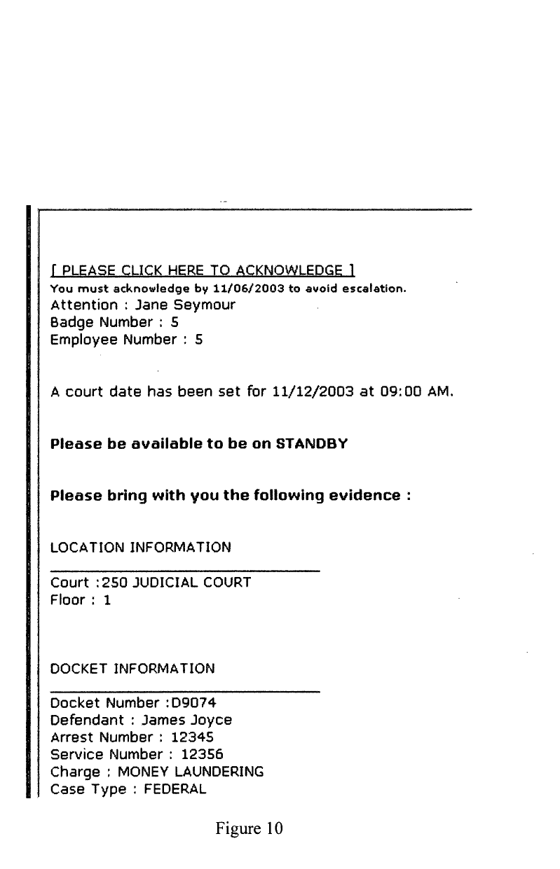

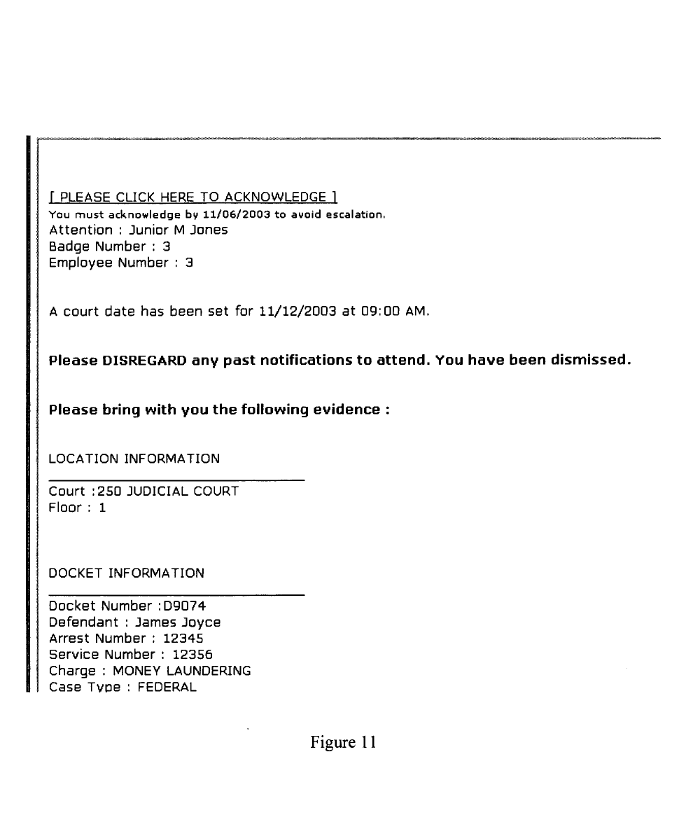

Generalizing, whenever a request type changes, the system preferably sends out an appropriate notification (e.g., Appear, Standby, or Disregard) to the witness (preferably by email), updates the witness's home screen regarding the new docket information, and changes their notification status to Notified. FIG. 9 illustrates a representative notification email notifying a witness that he or she is expected to Appear at a given court at a given date and time. FIG. 10 illustrates a representative notification email notifying a witness that he or she is on Standby to appear at a given court at a given date and time. FIG. 11 illustrates a representative notification email notifying a witness that he or she can disregard a past notification to attend (and that he or she has been dismissed). Each such email preferably includes an embedded link “Please Click Here To Acknowledge” that must be selected to avoid an escalation (i.e., a notice to the employee's supervisor).

As noted above, once a witness has been added to the docket, preferably the system automatically identifies any conflicts with that witness as it relates to the current docket court date. Conflicts include, for example, if a person is retired or has been terminated, if a person is no longer active in the system, or if a person has an approved leave that include the current court date. In the event of a conflict, preferably the notification icon and the Request Type buttons (in FIG. 7) are not available for the conflicted individual(s). If the Notify All button is selected by the user with respect to some other witness, these conflicted individuals are not notified. The system also preferably allows for a Reciprocal Date to be selected to provide the next available best date for personnel with leave conflicts. This is illustrated in FIG. 12, which is an updated version of the List of Witnesses and Notification Status (FIG. 7) where there are certain conflicts (as identified by the “Yes” value in the Conflict column). When this occurs, the user may select individual employee (someone who has a “Yes” in the Conflict column), which results in the display of the additional Suggest a Reciprocal Date link at the bottom of the page (as illustrated in FIG. 12). Selection of this link causes the system to enter the functionality described above with respect to FIG. 4.

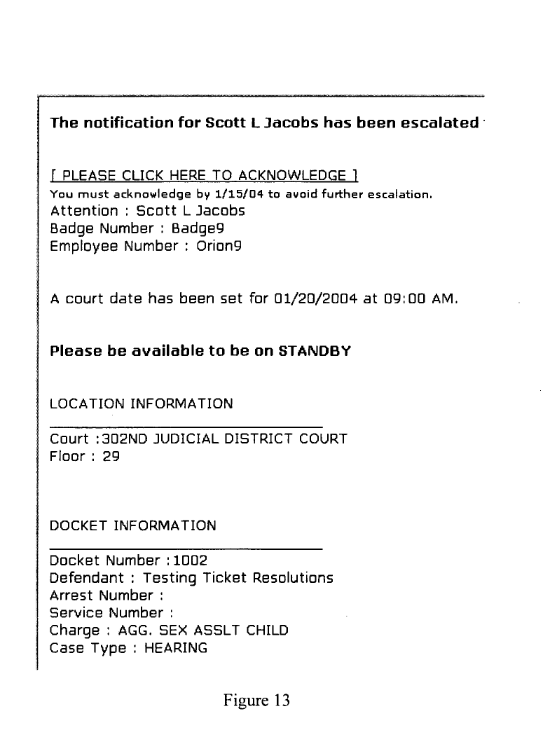

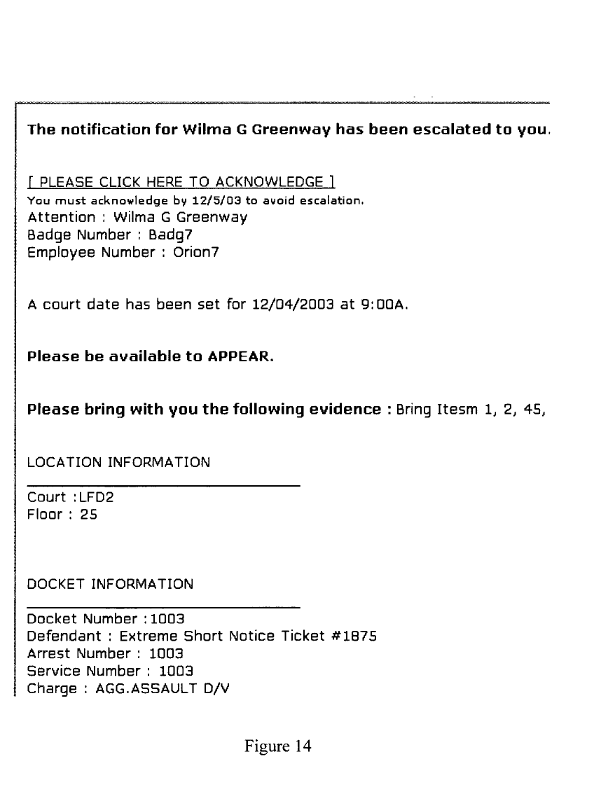

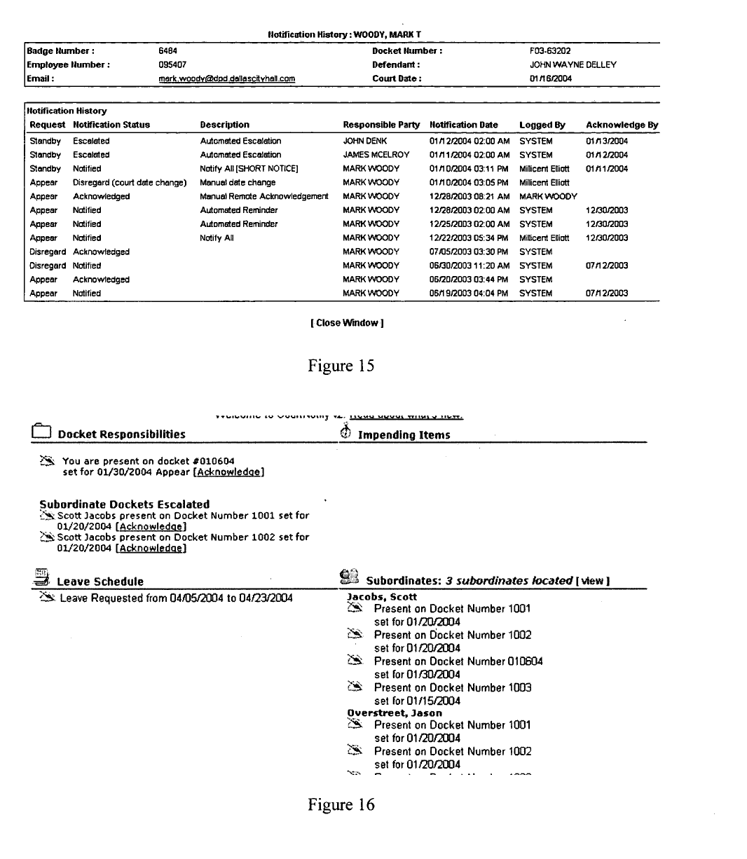

The system also preferably implements an automatic “escalation” notification (to an individual's selected supervisor) in the event an appearance notification is not acted upon. Preferably, the system allows an administrator to establish a policy or rule that determines the amount of time a witness has to acknowledge a notification. In the event the witness does not acknowledge within the given timeframe, an escalation is issued to the supervisor as well as to the witness. FIG. 13 illustrates an escalation email that is sent to the witness. FIG. 14 illustrates the escalation email that is sent to the supervisor. The supervisor receives the email escalation notice and, in turn, he or she is expected to provide acknowledgement to avoid further higher up escalation. If the witness responds to the escalation email (FIG. 13), the escalation process stops and the notification is deemed to be officially acknowledged. The supervisor preferably has several options: issue an acknowledge with exception (to allow a supervisor to stop a subpoena escalation and notify the court of an emergency situation for the witness), issue a personal acknowledgement (which refers to the supervisor contacting the witness directly, and then acknowledging the notification on behalf of the witness), or contact the witness and request he or she go online and either acknowledge the original notification email or acknowledge the docket from the employee's home display screen. Preferably, all activity associated with the notification process is tracked in a notification history for each witness associated with the docket, such as illustrated in FIG. 15. In this example, the history provides all details regarding what the request type was, the status of that request, the description, the party responsible for the request, when notification is due, and who logged the notification.

As noted above, in the event the supervisor does not acknowledge his or her escalation email, then within a given time period (variable time set per agency) the notification will escalate to the next level and eventually to the highest level in the system. This ensures accountability and prompt action where required.

A typical “witness” is a police officer who is expected to be summoned to appear in a particular court for a particular docket. A representative officer has a computer through which he or she can access a “home” display screen. A representative “home” screen for an officer is illustrated in FIG. 16. This display may have several portions or “quadrants”—a first quadrant identifying the person's docket responsibilities, a second quadrant identifying “impending” items, a third quadrant identifying leave schedules, and a fourth quadrant showing all subordinate schedules for dockets or leaves.

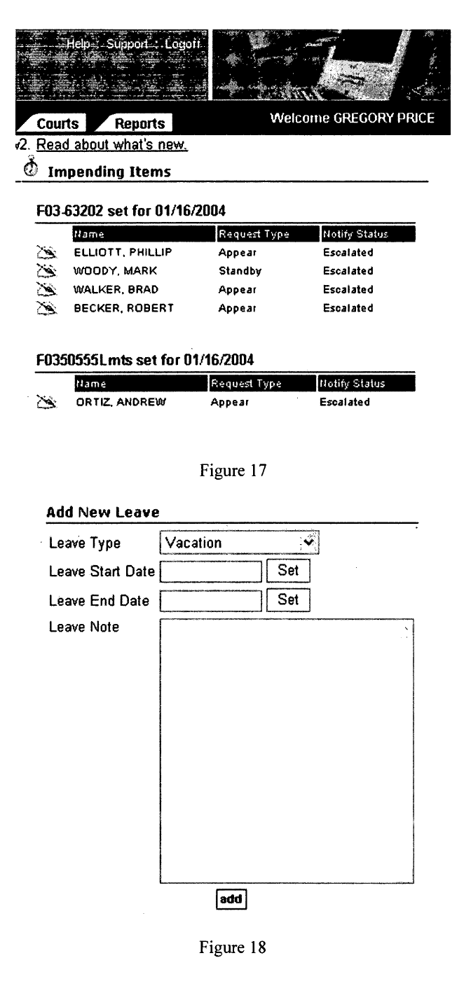

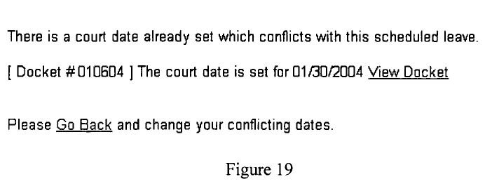

As illustrated in FIG. 16, the Docket Responsibilities portion displays all dockets involving the user and any escalations to that user from his or her subordinates for not acknowledging a notification. The Impending Items portion preferably displays a summation of any delinquent activity in the system that involves dockets that are less than a given time period (e.g., 5 days) until the court date. The impending items portion preferably shows all escalation within a given organization. FIG. 17 illustrates a more detailed representative display for the Impending Items portion in a particular example situation. Referring back to FIG. 16, the third quadrant includes links to leave schedules, and the fourth quadrant shows the subordinate activities. By clicking the view button, the supervisor can see a summary of the employee information. By clicking the link on any of the employee names, the user can view given detail, based on their given authority or permission to do so.

In a preferred embodiment, the system also includes appropriate routines to enable system users (typically police officers) to add scheduled leave time, to delete or edit a scheduled leave, and (as necessary) to resolve leave conflicts. This module interfaces with the notification functionality in the manner previously described. To schedule a leave date, a user (such as a police officer) navigates to an appropriate interface, such as illustrated in FIG. 18. The officer fills in the leave type, dates, and any notes, and then he or she selects the Add button. The system validates that the leave dates are not retroactive and that they do not overlap other approved or pending leave dates. Preferably, the system does not allow a leave to be requested for a date that a court docket subpoena notification has been issued to that officer to appear or to standby. If the leave request is validated, it is included in the leave schedule quadrant of the home screen. In addition, preferably the leave request is listed under the subordinate activities for the supervisor's home screen. Preferably, the system enables the user who requested the leave the ability to edit the leave or delete the leave until it is approved. Once the leave is approved, preferably the user is no longer allowed to edit the dates of the leave but can add comments. The user preferably can delete the leave request at any time. An immediate supervisor or any other supervisor in the same organization may approve or disapprove a submitted leave. Preferably, a supervisor cannot change the dates of a leave.

If a user requests a leave date that is in conflict with a docket notification, preferably the system inhibits the user from including the docket court date within the leave request.

One of ordinary skill in the art will appreciate that the present invention is subject to many variations. Thus, for example, while email notification has been described, this is not a requirement of the invention. Any convenient means of issuing a notification may be implemented; these include, for example, exporting an HTML page via HTTP, issuing an instant message, providing an electronic, voice or other data message, or the like. Likewise, a user may provide a given acknowledgement in any convenient manner, although selection of the embedded link with the email message is the preferred technique. Other techniques for issuing an acknowledgement include, without limitation, having a user log into the system and respond through an appropriate user interface independent of a particular notification, having the user activate a pager or similar device, having the user perform a “reply” to an email, having the user compose an independent email or other message, and the like.

The various control routines used to generate the display screens preferably are implemented in software as one or more computer programs. As used herein, such software typically comprises sets of instructions, code sequences, configuration information, and other data. The control functions described above are readily implemented in such code.

A distributed computing environment in which the court notification method and system of the invention may be implemented includes a set of computing-related entities (systems, machines, processes, programs, libraries, functions, or the like) that facilitate or provide a client-server network. In a typical implementation, the environment typically comprises a set of computers. A representative machine is a client workstation or a network-based server running commodity (e.g. Pentium-class) hardware, an operating system (e.g., Linux, Windows 2000, OS-X, or the like), an application runtime environment (e.g., Java), and a set of applications or processes (e.g., Java applets or servlets, linkable libraries, native code, or the like, depending on platform) that provide the functionality of a given system or subsystem. A client machine typically includes a Web browser (Internet Explorer, Netscape Navigator, Apple Safari, or the like) or other rendering engine. A Web browser typically includes or supports media players and other plug-ins. The present invention implements a distributed platform that enables employees to view and bid for work schedules over a network including, without limitation, the publicly-routable Internet, a corporate intranet, a private network, or any combination thereof. The method may be implemented as a standalone product, or as a managed service offering. Moreover, the method may be implemented at a single location, or across a set of locations. It may be implemented in a wide area network, a local area network, a virtual private network, or wireless network, or the like.

The present invention provides significant advantages. It provides a cost-effective docket scheduling solution using a standard web interface to schedule court dates, to notify police officers about appearing or standing by in court, and to respond with docket notice verification. The invention greatly simplifies the current complexity in the court scheduling process by automating the online scheduling and notification process for all entities (court personnel, police officers, and others) involved. The invention significantly decreases workforce redundancy and improves time management. As a result, both law enforcement and judicial services can more readily meet their funding and budget requirements.

The present invention provides numerous benefits in that it reduces unnecessary overtime costs for police personnel, it simplifies docket scheduling complexity, it decreases workforce redundancy, it provides documentation for notification, it facilitates accountability, it automates the rescheduling of conflicting dates, and improves time management for all personnel involved in the process.

The inventive online notification and confirmation system is preferably implemented within a distributed computing environment including at least one server. The invention does not require any modifications to conventional client or server machine hardware or software. Generalizing, the above-described functionality is implemented in software executable in a processor, namely, as a set of instructions (program code) in a code module resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or download via the Internet or other computer network.

In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Further, as used herein, a Web “client” should be broadly construed to mean any computer or component thereof directly or indirectly connected or connectable in any known or later-developed manner to a computer network, such as the Internet. The term Web “server” should also be broadly construed to mean a computer, computer platform, an adjunct to a computer platform, or any component thereof. Of course, a “client” should be broadly construed to mean one who requests or gets the file, and “server” is the entity which downloads the file.

The present invention is not limited for courts and law enforcement agencies. More generally, the invention can be implemented in any application environment where it is desired to have a first entity notify members of a second entity about given appearances or events. Thus, one of ordinary skill will appreciate that the basic techniques, functions, and operations of the inventive notification and confirmation system have broad applicability in other environments where it is required to provide real-time notifications.

Moreover, within the disclosed application court notification environment, the invention is capable of many variants. Thus, the various displays may be modified to provide additional functionality. For example, and with reference to the docket display in FIG. 1, it may be desirable to associate multiple charges with a specific docket, or to associate multiple hearings (each having a different date, or date and time) with the specific docket. In the latter case, the display would then include an additional pull-down menu selection from which a user would select a given hearing and then perhaps have the option to duplicate the witnesses already identified, or perhaps add or delete witnesses as required. The particular “ownership” of a given docket may be transferable to different members of the first entity, such as a first prosecutor and a second prosecutor, or between a prosecutor and an investigator, or the like. More than one government agency may have the ability to use the same docket. All such variations are considered within the scope of the present invention.

1. A method operated by a first entity for notifying given individuals of a second entity of required appearances, comprising:
having the first entity schedule a given appearance date for a given event;
identifying a list of one or more individuals of the second entity that are expected to be associated with the given event on the given appearance date;
for a given individual on the list, issuing a notification to the given individual identifying the given event and the given appearance date, the notification including a given request type and including an acknowledgement;
wherein one or more of the steps are performed by one or more electronic processing devices.

2. The method as described in claim 1 wherein the first entity is a court and the second entity is a law enforcement agency.

3. The method as described in claim 2 wherein the given event is a court appearance and the given individuals are police officers.

4. The method as described in claim 1 wherein the notification is an electronic communication.

5. The method as described in claim 4 wherein the electronic communication is an email and the acknowledgement is a hypertext link within the email.

6. The method as described in claim 1 wherein the given request type is selected from a set of request types that include appear, standby, disregard or not set.

7. The method as described in claim 1 further including the step of issuing a notification to all of the given individuals on the list concurrently.

8. The method as described in claim 7 wherein the notification places all of the given individuals on the list in a given status as a function of the given request type.

9. The method as described in claim 1 further including the step of adding an individual to the list of individuals.

10. The method as described in claim 1 further including the steps of:
changing the given appearance date, and:
for a given individual on the list, issuing a notification to the given individual identifying the given event and the changed appearance date, the notification including a given request type and including an acknowledgement.

11. The method as described in claim 1 further including the step of issuing an escalation notice if the given individual does not respond to the acknowledgement within a given time period.

12. The method as described in claim 11 wherein the escalation notice is issued to the given individual and to the given individual's supervisor.

13. A computer-implemented method operated by a court for notifying given individuals of a law enforcement agency of required court appearances, comprising:
having the court schedule a given appearance date for a given event;
identifying a list of one or more individuals of the law enforcement entity that are expected to be associated with the given event on the given appearance date;
for a given individual on the list, issuing a first notification to the given individual identifying the given event and the given appearance date, the notification including a given request type and including an acknowledgement;
determining whether the given individual has issued a given response to the acknowledgement within a given time period; and
if the given individual has not issued a given response to the acknowledgement with the given time period, issuing a second notification to the given individual and to the given individual's supervisor,
wherein one or more of the steps are performed by one or more electronic processing devices.

14. The method as described in claim 13 wherein the first notification is an email and the acknowledgement is a hypertext link within the email.

15. The method as described in claim 13 wherein the given request type is selected from a set of request types that include appear, standby, disregard or not set.

16. The method as described in claim 13 further including the step of maintaining a notification history for each given individual on the list.

17. The method as described in claim 13 further including the step of:
having the individual's supervisor issue a given response to the second notification, wherein the given response to the second notification is provided by the individual's supervisor on the given individual's behalf.

18. The method as described in claim 17 wherein the given response to the second notification is provided with an associated exception.

19. A method operated by a court for notifying given individuals of a law enforcement agency of required court appearances, comprising:
scheduling each of set of given individuals to a given court appearance on a appearance date, wherein each given individual also has an associated appear or standby status;
determining whether the given appearance date has been changed;
if the given appearance date has been changed, determining an alternative appearance date that does not conflict with the schedules of the given individuals and automatically providing each of the given individuals with a given notification, the notification including a given request type and including an acknowledgement;
wherein one or more of the steps are performed by one or more electronic processing devices.

20. The method as described in claim 19 wherein the given notification is an email indicating that the given court appearance on the given appearance date should be disregarded.

21. The method as described in claim 19 further including the step of changing the appear or standby status to a not notified status.

22. The method as described in claim 19 wherein the alternative appearance date is determined programmatically.

23. The method as described in claim 19 wherein the alternative appearance date is determined manually.
